(19) United States
(12) Patent Application Publication
(10) Pub. No.: US 2024/0001368 A1
(43) Pub. Date: Jan. 4, 2024

(54) HYDRATION AND HOMOGENIZATION OF LYOPHILIZED REAGENTS

(71) Applicant: Illumina, Inc., San Diego, CA (US)

(72) Inventors: Bradley DREWS, San Diego, CA (US); Mahmood GHANBARI MARDASI, San Diego, CA (US)

(21) Appl. No.: 18/343,842

(22) Filed: Jun. 29, 2023

Related U.S. Application Data
(60) Provisional application No. 63/367,391, filed on Jun. 30, 2022.

(51) Int. Cl. B01L 3/00

(52) U.S. Cl. CPC B01L 3/52; B01L 2200/16; B01L 2400/0622

(57) ABSTRACT

Provided are systems and methods including, under control of control circuitry implementing a hydration and homogenization protocol, hydrating lyophilized reagents and homogenizing the hydrated reagents. Lyophilized reagent nozzle sippers, including distal tips, extend into lyophilized reagent wells such that the distal tips do not contact the associated lyophilized reagent, designated amounts of hydration fluid are automatically aspirated from the corresponding hydration reservoir by corresponding sippers and discharged into the lyophilized reagent well based on the hydration and homogenization protocol implemented by the control circuitry. The method may also include extending the lyophilized reagent nozzle sippers into lyophilized reagent wells such that the distal tips contact the hydrated reagent, and automatically aspirating and discharging the hydrated reagent based on the hydration and homogenization protocol implemented by the control circuitry.

### CROSS-REFERENCE TO RELATED APPLICATIONS

This application claims benefit of U.S. Provisional Patent Application Ser. No. 63/367,391, filed Jun. 30, 2022, which is hereby incorporated by reference in its entirety.

### FIELD

The present disclosure relates generally to systems and methods for hydrating and homogenizing one or more lyophilized reagents. More particularly, the present disclosure includes methods for performing a hydration operation and a mixing operation, wherein the lyophilized reagent nozzle sipper is extended into a well containing a lyophilized reagent to a first position during hydration and to a second position during mixing. The present disclosure also relates generally to systems for performing the methods, including a fluid manifold with one or more lyophilized reagent nozzle sippers, a pump, a bypass valve, and control circuitry to implement the methods.

### BACKGROUND

Instruments have been developed and continue to evolve for sequencing molecules of interest, particularly DNA, RNA and other biological samples. In advance of sequencing operations, samples of the molecules of interest are prepared in order to form a library or template which will be mixed with reagents and ultimately introduced into a flow cell where individual molecules will attach at sites and be amplified to enhance detectability. The sequencing operation, then, includes repeating a cycle of steps to bind the molecules at the sites, tag the bound components, image the components at the sites, and process the resulting image data. In such sequencing systems, fluidic systems (or subsystems) provide the flow of substances (e.g., the reagents) under the control of a control system, such as a programmed computer and appropriate interfaces.

The stability of reagents involved with sample preparation varies depending on a variety of factors. Historically, reagents have often been wet, that is, in liquid form at room temperature, and thus current systems and methods are designed for the use of wet reagents, which often involves freezing for shipping and storage. Moving to dry reagents may allow for ambient transport and storage. However, dry reagents may be more sensitive than wet reagents to undesirable environmental conditions during manufacture, transport, storage, and sample preparation. Lyophilized reagents present an alternative to wet reagents, though they may involve different systems and methods to accommodate preparation, e.g., hydration, before use. Current systems and methods may benefit from streamlined use of lyophilized reagents.

Therefore, there is a need for improved sample preparation systems and methods. In particular, there is a need for systems and methods utilizing lyophilized sequencing reagents.

The present disclosure is directed to overcoming these and other deficiencies in the art.

### SUMMARY

Details of one or more implementations of the subject matter described in this specification are set forth in the accompanying drawings and the description below. Other features, aspects, and advantages will become apparent from the description, the drawings, and the claims.

An aspect relates to a system including a fluid manifold including multiple lyophilized reagent nozzle sippers and a bypass valve, the lyophilized reagent nozzle sippers each including a distal tip and extending into a corresponding lyophilized reagent well containing a lyophilized reagent therein such that before hydration the distal tip does not contact the lyophilized reagent and after hydration the distal tip contacts hydrated reagent, the bypass valve fluidly connected to the lyophilized reagent nozzle sippers; a pump fluidly connected to the bypass valve; a control circuitry operatively connected to the lyophilized reagent nozzle sippers, bypass valve, and pump, the control circuitry controlling the lyophilized reagent nozzle sippers, the bypass valve, and the pump to automatically hydrate the lyophilized reagents and homogenize the hydrated reagent.

In an implementation, the system includes a bypass line between the bypass valve and the pump, wherein the bypass line is fluidly connected to the pump. In another implementation, the system further includes a bypass cache between the pump and the bypass valve, the bypass cache including a heating chamber, and wherein the bypass cache is fluidly connected to the bypass valve. In yet another implementation, the fluid manifold includes one or more hydration sipper and each of the one or more hydration sipper includes a distal tip and extends into a corresponding hydration reagent reservoir containing a hydration fluid.

In still another implementation, the control circuitry controls the pump to hydrate the lyophilized reagent by aspirating a volume of the hydration fluid and dispensing the volume of the hydration fluid onto the lyophilized reagent in the lyophilized reagent well, resulting in a hydrated reagent. In a further implementation, the control circuitry controls the pump to dilute the hydrated reagent by aspirating a second volume of the hydration fluid and dispensing the second volume of hydration fluid into the lyophilized reagent well. In yet a further implementation, a flow rate when aspirating the second volume of hydrated reagent is less than or equal to a flow rate when dispensing the second volume of hydrated reagent. In still a further implementation, a flow rate when aspirating the second volume of hydrated reagent is less than a flow rate when dispensing the second volume of hydrated reagent.

In another implementation, the control circuitry controls the pump and the lyophilized reagent nozzle sipper to homogenize the hydrated reagent by positioning the lyophilized reagent nozzle sipper such that the distal tip contacts the hydrated reagent, aspirating the hydrated reagent and dispensing it back into the lyophilized reagent well, and repeating the steps of aspirating and dispensing until the hydrated reagent is homogeneous.

In an implementation, the control circuitry controls the pump and the bypass cache to polish the homogeneous hydrated reagent, wherein the homogeneous hydrated reagent is aspirated to the bypass cache, heated, dispensed back into the lyophilized reagent well, aspirated to the bypass cache a second time, heated a second time, cooled, and dispensed into a buffer well containing a buffer fluid. In another implementation, the control circuitry controls the pump to add a third component to the buffer well by aspirating an amount of the third component and dispensing the amount of the third component into the buffer well.

Another aspect relates to a method of utilizing the system, the method including: (a) performing a hydration operation including: actuating the pump to aspirate the hydration fluid, commanding one of the multiple lyophilized reagent nozzle sipper to extend to a first position into the corresponding lyophilized reagent well, and actuating the pump to dispense the hydration fluid into the corresponding lyophilized reagent well, thereby forming the hydrated reagent; and (b) performing a mixing operation including: commanding the one of the multiple lyophilized reagent nozzle sippers to extend to a second position within the corresponding lyophilized reagent well, and actuating the pump to mix the hydrated reagent.

In an implementation, the method further includes (c) performing a dilution operation before the mixing operation, including: actuating the pump to aspirate a dilution fluid, and actuating the pump to dispense the dilution fluid into the corresponding lyophilized reagent well.

In another implementation, the method further includes (d) performing a polishing operation after the mixing operation, including: actuating the pump to aspirate the hydrated reagent to a bypass cache including a heating chamber, commanding the heating chamber to heat the hydrated reagent, dispensing the hydrated reagent back into the corresponding lyophilized reagent well, actuating the pump to aspirate the hydrated reagent to the heating chamber of the bypass cache, commanding the heating chamber to heat the hydrated reagent a second time, and cooling the hydrated reagent, thereby forming a polished reagent.

In yet another implementation, the method further includes (e) performing a second mixing operation, including: actuating the pump to dispense the polished reagent into a buffer well containing a buffer fluid, actuating the pump to aspirate a third component, actuating the pump to dispense the third component into the buffer well, and actuating the pump to aspirate the solution in the buffer well and dispense it back into the buffer well, there mixing the solution.

Yet another aspect relates to a method including: implementing a hydration protocol under control of a control circuitry, including extending a lyophilized reagent nozzle sipper into a lyophilized reagent well to a first position above a lyophilized reagent, aspirating a volume of hydration fluid from a hydration reservoir, dispensing the volume of hydration fluid into the lyophilized reagent well to form a hydrated reagent; and implementing a homogenization protocol under control of the control circuitry, including extending the lyophilized reagent nozzle sipper to a second position wherein the lyophilized reagent nozzle sipper contacts the hydrated reagent, aspirating an amount of the hydrated reagent, and dispensing the amount of hydrated reagent into the same well.

In an implementation, the method further includes: after the hydration protocol is implemented and before the homogenization protocol is implemented, implementing a dilution protocol under control of the control circuitry, wherein the dilution control includes aspirating a dilution fluid from a dilution reservoir into a bypass cache and dispensing the dilution fluid into the lyophilized reagent well.

In another implementation, the method further includes: after the homogenization protocol is implemented, implementing a polishing protocol under control of the control circuitry, wherein the polishing protocol includes aspirating the homogenized reagent into a bypass cache and heating the homogenized reagent in the bypass cache a first time, dispensing the homogenized reagent back into the lyophilized reagent well, aspirating the homogenized reagent into the bypass cache and heating the homogenized reagent in the bypass cache a second time, cooling the homogenized reagent, and dispensing the resulting polished reagent into a buffer well.

In still another implementation, the method further includes: after the polishing protocol is implemented, implementing a mixing protocol under control of the control circuitry, wherein the mixing protocol includes aspirating a third component and dispensing the third component into the buffer well, aspirating the mixture of polished reagent and third component and dispensing back into the buffer well.

In yet another implementation, during the homogenization protocol a flow rate when dispensing is greater than or equal to a flow rate when aspirating. In still another implementation, during the homogenization protocol the flow rate when dispensing is greater than the flow rate when aspirating.

In a further implementation, during the mixing protocol a flow rate when dispensing is greater than or equal to a flow rate when aspirating. In yet a further implementation, during the mixing protocol the flow rate when dispensing is greater than the flow rate when aspirating.

Still another aspect relates to a system including: a flow path fluidly connected to a flow cell; a plurality of hydration sippers fluidly connected to the flow path; a plurality of lyophilized reagent nozzle sippers fluidly connected to a bypass cache; a selector valve fluidly connected to the plurality of hydration sippers and the plurality of lyophilized reagent nozzle sippers; a bypass valve fluidly connected to the selector valve and the bypass cache; a pump fluidly connected to the bypass cache; and a control circuitry operatively coupled to the plurality of lyophilized reagent nozzle sippers, selector valve, the bypass valve, and the pump, the control circuitry having one or more processors and a memory that stores machine-executable instructions which, when executed by the one or more processors: (a) cause the selector valve to select a hydration sipper of the plurality of hydration sippers associated with a hydration fluid, (b) cause the pump to aspirate a hydration fluid from the selected hydration sipper and to deliver the hydration fluid to the bypass cache, (c) cause the selector valve to select a lyophilized reagent nozzle sipper associated with a lyophilized reagent to be rehydrated, (d) cause the selected lyophilized reagent nozzle sipper to be positioned at a first position above the associated lyophilized reagent, (e) cause the pump to dispense the aspirated hydration fluid from the bypass cache to the well containing the lyophilized reagent, thereby forming a hydrated reagent, (f) cause the selector valve to reselect the hydration sipper associated with the hydration fluid, (g) cause the pump to aspirate the hydration fluid from the selected hydration sipper, deliver the hydration fluid to the bypass cache, and dispense the aspirated hydration fluid to a first well containing the hydrated reagent, (h) cause the selected lyophilized reagent nozzle sipper to be positioned at a second position, wherein the distal tip contacts the hydrated reagent, and (i) cause the pump to aspirate the hydrated reagent, deliver the hydrated reagent to the bypass cache, and dispense the hydrated reagent into the first well, thereby homogenizing the hydrated reagent.

In an implementation, the bypass cache includes a heating chamber and the instructions further: (j) cause the pump to aspirate the homogenized hydrated reagent, deliver the homogenized hydrated reagent to the bypass cache, heat the homogenized hydrated reagent a first time, and dispense into the first well, (k) cause the pump to aspirate the homogenized hydrated reagent, deliver the homogenized hydrated reagent to the bypass cache, heat the homogenized hydrated reagent a second time, thereby polishing the hydrated reagent, and (l) cool the polished reagent in the bypass cache.

In another implementation, the instructions further (m) cause the pump to dispense the polished hydrated reagent in a second well, the second well including a second component, (n) cause the pump to aspirate the mixture, deliver the mixture to the bypass cache, and dispense the mixture into the second well, thereby mixing the polished hydrated reagent and the second component.

In yet another implementation, the instructions further (o) cause the pump to aspirate a third component to the bypass cache, and dispense the third component into the second well containing the polished hydrated reagent and the second component, and (p) cause the pump to aspirate the mixture of polished hydrated reagent, second component, and third component, to the bypass cache, and dispense the mixture into the second well, thereby mixing the polished hydrated reagent, the second component, and the third component.

A further aspect relates to a method utilizing the system including (a) performing a hydration operation including: commanding the selector valve to select a hydration sipper of the plurality of hydration sippers extending into a reservoir associated with a hydration fluid, actuating the pump to aspirate the hydration fluid to the bypass cache, commanding the selector valve to select a lyophilized reagent nozzle sipper extending into a first well associated with a lyophilized reagent, commanding the selected lyophilized reagent nozzle sipper to extend to a first position within the first well, actuating the pump to dispense the hydration fluid from the bypass cache into the first well associated with the lyophilized reagent, thereby forming a hydrated reagent, commanding the selector valve to select a hydration sipper extending into a reservoir associated with a hydration fluid, actuating the pump to aspirate the hydration fluid to the bypass cache, commanding the selector valve to select a lyophilized reagent nozzle sipper extending into the first well containing the hydrated reagent, actuating the pump to dispense the hydration fluid from the bypass cache into the well associated with the hydrated reagent, thereby diluting the hydrated reagent, and (b) performing a homogenization operation including: commanding the selected lyophilized reagent nozzle sipper to extend to a second position within the well, and actuating the pump to homogenize the hydrated reagent.

In an implementation, the method further includes: (c) performing a polishing operation including: actuating the pump to aspirate the homogenized hydrated reagent to the bypass cache, commanding the heating chamber in the bypass cache to heat the homogenized hydrated reagent a first time, actuating the pump to dispense the homogenized hydrated reagent to the first well, actuating the pump to aspirate the homogenized hydrated reagent to the bypass cache, commanding the heating chamber in the bypass cache to heat the homogenized hydrated reagent a second time, and actuating the pump to dispense the polished hydrated reagent into a second well.

In another implementation, the method further includes: (d) performing a mixing operation including: commanding the selector valve to select a reagent, actuating the pump to aspirate the reagent to the bypass cache, actuating the pump to dispense the reagent in the second well containing the polished hydrated reagent, thereby forming a mixture, actuating the pump to aspirate the mixture, and actuating the pump to dispense the mixture, thereby mixing the mixture.

In yet another implementation, the second well contains a buffer. In still another implementation, a flow rate during aspirating of the mixture is less than or equal to a flow rate during dispensing of the mixture. In a further implementation, a flow rate during aspirating of the mixture is less than a flow rate during dispensing of the mixture.

Yet a further aspect relates to a system including: a fluidic system, a plurality of hydration sippers, and a plurality of lyophilized reagent nozzle sippers, wherein the fluidic system including a plurality of hydration flow paths, a plurality of lyophilized reagent flow paths, a selector valve, and a bypass cache, wherein: each of the plurality of hydration flow paths has a first end configured to be fluidly connected with a different hydration recipient of a plurality of hydration recipients and a second end fluidly connected with the selector valve, each of the plurality of lyophilized reagent flow paths has a first end configured to be fluidly connected with a different lyophilized reagent recipient of a plurality of lyophilized reagent recipients and a second end fluidly connected with the selector valve, and the selector valve is fluidly connected with the bypass cache; the plurality of hydration sippers are fluidly connected with the plurality of hydration flow paths; and the plurality of lyophilized reagent nozzle sippers are fluidly connected with the plurality of lyophilized reagent flow paths, extend to a first position when the fluidic system hydrates the lyophilized reagent, and extend to a second position wherein the lyophilized reagent nozzle sipper contacts the hydrated reagent when the fluidic system homogenizes the hydrated reagent.

Still a further aspect relates to an instrument including: a housing; a fluid manifold disposed within the housing, the fluid manifold including multiple channels fluidly connected to lyophilized reagent nozzle sippers that extend to a first position or a second position into different corresponding wells, each well associated with a lyophilized reagent, wherein the lyophilized reagent nozzle sippers contact the hydrated reagent when in the second position; a reagent selector valve disposed within the housing and operatively connected to at least two of the channels of the manifold; a bypass valve disposed within the housing and operatively connected to the reagent selector valve; a bypass cache disposed within the housing and operatively connected to the bypass valve; and a pump disposed within the housing and operatively connected to the channels of the fluid manifold, and fluidly connected to the bypass cache.

Another aspect relates to an apparatus including a lyophilized reagent sipper that is extendable from a first position to a second position and a third position, where the distance between the first position and the third position is greater than the distance between the first position and the second position. In an implementation, the apparatus further includes a removable cartridge including a well, wherein the lyophilized reagent sipper extends into the well of the cartridge when the lyophilized reagent sipper is in the second position and the third position, and wherein the lyophilized reagent sipper does not extend into the well of the cartridge when the lyophilized reagent supper is in the first position. In another implementation, the lyophilized reagent sipper extends into the well above a lyophilized cake housed within the well when the lyophilized reagent sipper is in the second position, and wherein the lyophilized reagent sipper extends into the well and into rehydrated lyophilized reagent housed within the well when the lyophilized reagent sipper is in the third position.

In yet another implementation the lyophilized reagent sipper further includes a center line and a distal end, where the distal end includes facets and a nozzle, where the facets meet at an apex that is offset or eccentric with respect to the centerline, and where the centerline extends through the nozzle. In still another implementation the distal end includes four facets. In a further implementation the lyophilized reagent sipper further includes a nozzle insert, where the lyophilized reagent sipper has an inner diameter and the nozzle insert has an inner diameter, where the inner diameter of the nozzle insert is about one-half of the inner diameter of the lyophilized reagent sipper.

### BRIEF DESCRIPTION OF THE FIGURES

These and other features, aspects, and advantages of the present disclosure will become better understood when the following detailed description is read with reference to the accompanying drawings in which like characters represent like parts throughout the drawings, wherein:

FIG. 1 is a diagrammatical overview of an example sequencing system in which the disclosed techniques may be employed;

FIG. 2 is a diagrammatical overview of an example fluidic system of the sequencing system of FIG. 1;

FIG. 3 is a diagrammatical overview of an example processing and control system of the sequencing system of FIG. 1;

FIG. 4 illustrates an example sequencing system in which the disclosed techniques may be employed;

FIGS. 5A and 5B illustrate an example manifold of the sequencing system; a top view (5A) and a perspective view (5B);

FIG. 6 illustrates a perspective view of an example arrangement of the sequencing system, including an example sipper manifold assembly and associated components;

FIG. 7 is a diagrammatical section of an example destination well for mixed reagent and showing a nozzle sipper ejecting mixed reagents into the well;

FIGS. 8A-8D illustrate an example lyophilized reagent nozzle sipper which may be included in the disclosed system;

FIG. 9 illustrates a sipper positioned within a well;

FIG. 10 is a flow chart illustrating example logic for aspirating and mixing reagents and a sample template;

FIG. 11 is a diagrammatical overview of an example protocol for hydration and homogenization of a lyophilized reagent;

FIG. 12 is a flow chart illustrating an example logic for hydrating and homogenizing a lyophilized reagent;

FIG. 13 is a diagrammatical overview of an example hydration and homogenization protocol;

FIG. 14 is a diagrammatical overview of an example protocol for hydration, homogenization, and polishing of a lyophilized reagent;

FIG. 15 is a flow chart illustrating an example logic for hydrating, homogenizing, and polishing a lyophilized reagent; and

FIG. 16 is a diagrammatical overview of an example hydration and homogenization protocol.

It should be appreciated that all implementations, and combinations of such, of the foregoing concepts and additional concepts discussed in greater detail below (provided such concepts are not mutually inconsistent) are contemplated as being part of the inventive subject matter disclosed herein and may be used to achieve the benefits and advantages described herein.

### DETAILED DESCRIPTION

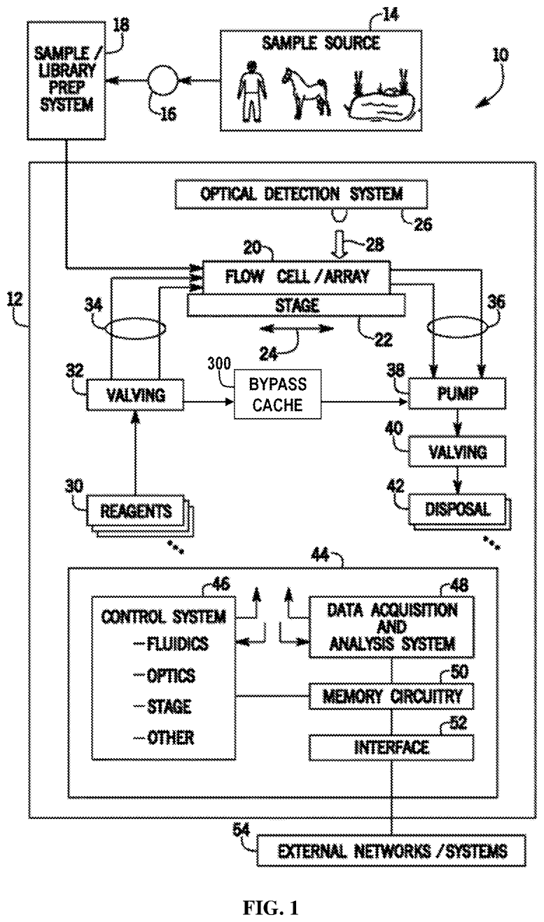

FIG. 1 illustrates an implementation of a sequencing system 10 configured to process molecular samples that may be sequenced to determine their components, the component ordering, and generally the structure of the sample. The system includes an instrument 12 that receives and processes a biological sample. A sample source 14 provides the sample 16 which in many cases will include a tissue sample. The sample source may include, for example, an individual or subject, such as a human, animal, microorganism, plant, or other donor (including environmental samples), or any other subject that includes organic molecules of interest, the sequence of which is to be determined. The system may be used with samples other than those taken from organisms, including synthesized molecules. In many cases, the molecules will include DNA, RNA, or other molecules having base pairs the sequence of which may define genes and variants having particular functions of ultimate interest.

The sample 16 is introduced into a sample/library preparation system 18. This system may isolate, break, and otherwise prepare the sample for analysis. The resulting library includes the molecules of interest in lengths that facilitate the sequencing operation. The resulting library is then provided to the instrument 12 where the sequencing operation is performed. In practice, the library, which may sometimes be referred to as a template, is combined with reagents in an automated or semi-automated process, and then introduced to the flow cell prior to sequencing.

In the implementation illustrated in FIG. 1, the instrument includes a flow cell or array 20 that receives the sample library. The flow cell may include one or more fluidic channels that allow for sequencing chemistry to occur, including attachment of the molecules of the library, and amplification at locations or sites that can be detected during the sequencing operation. For example, the flow cell/array 20 may include sequencing templates immobilized on one or more surfaces at the locations or sites. A “flow cell” may include a patterned array, such as a microarray, a nanoarray, and so forth. In practice, the locations or sites may be disposed in a regular, repeating pattern, a complex non-repeating pattern, or in a random arrangement on one or more surfaces of a support. To enable the sequencing chemistry to occur, the flow cell may also allow for introduction of substances, such as including various reagents, buffers, and other reaction media, that may be used for reactions, flushing, and so forth. The substances may flow through the flow cell and may contact the molecules of interest at individual sites. In some implementations, substances may initially bypass the flow cell during preparation via bypass cache 300. For example, lyophilized reagents may be hydrated, mixed and/or polished via a bypass circuit including bypass cache 300, as described herein. In some implementations, the lyophilized reagent is in the form of a cake and referred to as a lyophilized reagent cake.

In an implementation, a flow cell 20 may be mounted on a movable stage 22 that may be moved in one or more directions as indicated by reference numeral 24. The flow cell 20 may, for example, be provided in the form of a removable and replaceable cartridge that may interface with ports on the movable stage 22 or other components of the system in order to allow reagents and other fluids to be delivered to or from the flow cell 20. The stage may be associated with an optical detection system 26 that may direct radiation or light 28 to the flow cell during sequencing. The optical detection system may employ various methods, such as fluorescence microscopy methods, for detection of the analytes disposed at the sites of the flow cell. By way of a non-limiting example, an optical detection system 26 may employ confocal line scanning to produce progressive pixilated image data that may be analyzed to locate individual sites in the flow cell and to determine the type of nucleotide that was most recently attached or bound to each site. Other suitable imaging techniques may also be employed, such as techniques in which one or more points of radiation are scanned along the sample or techniques employing “step and shoot” imaging approaches. An optical detection system 26 and stage 22 may cooperate to maintain the flow cell and detection system in a static relationship while obtaining an area image, or, as noted, the flow cell may be scanned in any suitable mode (e.g., point scanning, line scanning, “step-and-shoot” scanning).

While many different technologies may be used for imaging, or more generally for detecting molecules at sites, an implementation may make use of confocal optical imaging at wavelengths that cause excitation of fluorescent tags. The tags, excited by virtue of their absorption spectrum, may return fluorescent signals by virtue of their emission spectrum. An optical detection system 26 may be configured to capture such signals, to process pixelated image data at a resolution that allows for analysis of the signal-emitting sites, and to process and store the resulting image data (or data derived from it).

In a sequencing operation, cyclic operations or processes may be implemented in an automated or semi-automated fashion in which reactions are promoted, such as with single nucleotides or with oligonucleotides, followed by flushing, imaging and de-blocking in preparation for a subsequent cycle. A sample library, prepared for sequencing and immobilized on a flow cell, may undergo a number of such cycles before all useful information is extracted from a library. An optical detection system may generate image data from scans of the flow cell (and its sites) during each cycle of sequencing operation by use of electronic detection circuits (e.g., cameras or imaging electronic circuits or chips). Resulting image data may then be analyzed to locate individual sites in the image data, and to analyze and characterize the molecules present at the sites, such as by reference to a specific color or wavelength of light (a characteristic emission spectrum of a particular fluorescent tag) that is detected at a specific location, as indicated by a group or cluster of pixels in the image data at the location. In a DNA or RNA sequencing application, for example, the four common nucleotides may be represented by distinguishable fluorescence emission spectra (wavelengths or wavelength ranges of light). Each emission spectrum, then, may be assigned a value corresponding to that nucleotide. Based upon this analysis, and tracking the cyclical values determined for each site, individual nucleotides and their orders may be determined for each site. These sequences may then be further processed to assemble longer segments including genes, chromosomes, and so forth. As used in this disclosure the terms “automated” and “semi-automated” mean that the operations are performed by system programming or configuration with little or no human interaction once the operations are initiated, or once processes including the operations are initiated.

In the illustrated implementation, reagents 30 are drawn or aspirated into the flow cell through valving 32. The valving may access the reagents from recipients or vessels in which they are stored, such as through pipettes or sippers (not shown in FIG. 1). The valving 32 may allow for selection of the reagents based upon a prescribed sequence of operations performed. The valving may further receive commands for directing the reagents through flow paths 34 into the flow cell 20. Exit or effluent flow paths 36 direct the used reagents from the flow cell. In the illustrated implementation, a pump 38 serves to move the reagents through the system. The pump may also serve other useful functions, such as measuring reagents or other fluids through the system, aspirating air or other fluids, and so forth. Additional valving 40 downstream of pump 38 allows for appropriately directing the used reagent to disposal vessels or recipients 42.

The instrument further includes a range of circuitry that aids in commanding the operation of the various system components, monitoring their operation by feedback from sensors, collecting image data, and at least partially processing the image data. In the implementation illustrated in FIG. 1, a control/supervisory system 44 includes a control system 46 and a data acquisition and analysis system 48. Both systems will include one or more processors (e.g., digital processing circuits, such as microprocessors, multi-core processors, FPGA's, or any other suitable processing circuitry) and associated memory circuitry 50 (e.g., solid state memory devices, dynamic memory devices, on and/or off-board memory devices, and so forth) that may store machine-executable instructions for controlling, for example, one or more computers, processors, or other similar logical devices to provide certain functionality. Application-specific or general purpose computers may at least partially make up the control system and the data acquisition and analysis system. A control system may include, for example, circuitry configured (e.g., programmed) to process commands for fluidics, optics, stage control, and any other useful functions of the instrument. A data acquisition and analysis system 48 may interface with an optical detection system to command movement of the optical detection system or stage, or both, the emission of light for cyclic detection, receiving and processing of returned signals, and so forth. The instrument may also include various interfaces as indicated at reference 52, such as an operator interface that permits control and monitoring of the instrument, transfer of samples, launching of automated or semi-automated sequencing operations, generation of reports, and so forth. Finally, in the implementation of FIG. 1, external networks or systems 54 maybe coupled to and cooperate with the instrument, for example, for analysis, control, monitoring, servicing, and other operations.

In some implementations, reagents 30 include other substances used in the system, for example, wash buffers, hydration fluids, etc. Such substances may be in liquid form or lyophilized. In some implementations, liquid substances may be selected via valving 32, drawn or aspirated into bypass cache 300, and dispensed into wells (e.g., vessels or recipients) containing lyophilized reagents 30 or other lyophilized substances, thereby hydrating the lyophilized reagent or substance. In some implementations, valving 32 may receive commands for directing reagents 30 or substances to bypass cache 300, and bypass cache 300 may receive commands to heat reagents 30 or substances to polish them. For example, lyophilized fully functionalized nucleotides (ffNs) may be hydrated, homogenized, and polished by iteratively aspirating to bypass cache 300 and heating. In an example, a lyophilized substance or a lyophilized reagent, or a hydrating solution, may include a polishing polymerase, such that a solution including rehydrated lyophilized ffNs also includes a polishing polymerase. In another example, a polishing polymerase may be included in a bypass cache into which a rehydrated lyophilized ffNs are aspirated, or polishing polymerase may be aspirated or added to rehydrated lyophilized ffNs in a bypass cache.

It may be noted that while a single flow cell and fluidics path, and a single optical detection system are illustrated in FIG. 1, in some instruments more than one flow cell and fluidics path may be accommodated. For example, in a presently contemplated implementation, two such arrangements are provided to enhance sequencing and throughput. In practice, any number of flow cells and paths may be provided. These may make use of the same or different reagent receptacles, disposal receptacles, control systems, image analysis systems, and so forth. Where provided, the multiple fluidics systems may be individually controlled or controlled in a coordinated fashion. It is to be understood that the phrase “fluidically connected” may be used herein to describe connections between two or more components that place such components in fluidic communication with one another, much in the same manner that “electrically connected” may be used to describe an electrical connection between two or more components. The phrase “fluidically interposed” may be used, for example, to describe a particular ordering of components. For example, if component B is fluidically interposed between components A and C, then fluid flowing from component A to component C would flow through component B before reaching component C.

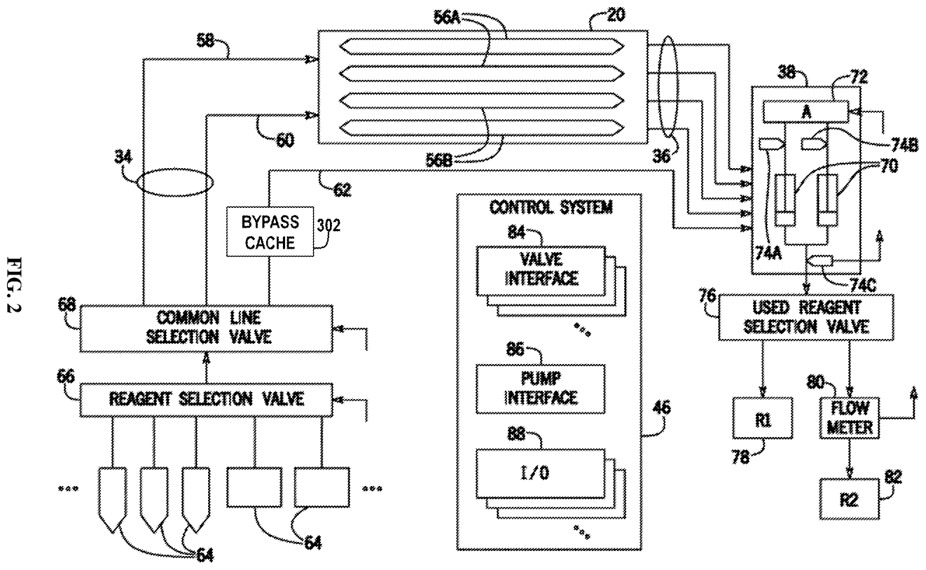

FIG. 2 illustrates an example fluidic system of the sequencing system of FIG. 1. In the implementation illustrated, the flow cell 20 includes a series of pathways or lanes 56A and 56B which may be grouped in pairs for receiving fluid substances (e.g., reagents, buffers, reaction media) during sequencing operations. The lanes 56A are coupled to a common line 58 (a first common line), while the lanes 56B are coupled to a second common line 60. A bypass line 62 is also provided to allow fluids to bypass the flow cell without entering it. As noted above, a series of vessels or recipients 64 allow for the storage of reagents and other fluids that may be utilized during the sequencing operation. A reagent selector valve 66 is mechanically coupled to a motor or actuator (not shown) to allow selection of one or more of the reagents to be introduced into the flow cell. Selected reagents are then advanced to a common line selector valve 68 which similarly includes a motor (not shown). The common line selector valve may be commanded to select one or more of the common lines 58 and 60, or both common lines, to cause the reagents 64 to flow to the lanes 56A and/or 56B in a controlled fashion, or the bypass line 62 to flow one or more of the reagents through the bypass line. It may be noted that other useful operations may be enabled by the bypass line, such as the ability to prime all reagents (and liquids) to the reagent selector valve (and the common line selector valve) without drawing air through the flow cell, the ability to perform washing (e.g., automated or semi-automated washing) of the reagent channels and sippers independent of the flow cell, and the ability to perform diagnostic functions (e.g., pressure and volume delivery tests) on the system.

In some implementations, bypass line 62 may further include bypass cache 302, and selected reagents may be advanced to bypass cache 302 in order to bypass flow cell 20. For example, substances may be selected by reagent selection valve 66, advanced to bypass cache 302, and then dispensed into a lyophilized reagent well or vessel. Further, two or more substances may be mixed by using the bypass circuit including bypass line 62 and bypass cache 302. For example, a substance may be aspirated to bypass cache 302 and dispensed into a different well or vessel containing a different substance. Moreover, the bypass circuit may be used to bypass flow cell 20 in order to hydrate a lyophilized reagent or substance. For example, a hydration fluid may be selected by reagent selection valve 66, aspirated to bypass cache 302, and dispensed or expelled into a lyophilized reagent well or vessel. In addition, bypass cache 302 may include a heating chamber for polishing reagents/substances, such as ffNs.

“Polishing” means purifying 3′-blocked nucleotides by removing unblocked (3′-OH) nucleotides from solution before beginning sequencing-by-synthesis (SBS) or genotyping operations. For example, 3′-blocked nucleotides may include a blocking group, e.g., an azidomethyl group, coupled to the nucleotide at the 3′ position. The nucleotides also may be coupled to a detectable moiety, such as a fluorophore. When an SBS polymerase polymerizes the 3′-blocked nucleotides by adding a given one of the nucleotides to a growing polynucleotide according to a complementary polynucleotide (e.g., a template to be sequenced), that one of the nucleotides may be detected and identified by detection of its detectable moiety, thus allowing a nucleotide complementary to a nucleotide of the template to be identified. However, a polymerase may be unable to add another nucleotide to the growing polynucleotide until the 3′-blocking group is removed using a suitable reagent. After the 3′-blocking group is removed, the detectable moiety may be cleaved from that nucleotide and add another 3′-blocked nucleotide to the growing polynucleotide. Such a process may be repeated any suitable number of times, e.g., so as to identify one or more bases in the sequence of the complementary polynucleotide. The detectable moieties of the various 3′-blocked nucleotides may be detected via suitable detection circuitry. In some examples, detectable moieties may include fluorophores that may be detected via suitable optical detection circuitry. However, it will be appreciated that a detectable moiety may be detected in any suitable manner and is not limited to detection via fluorescence.

The presence of 3′-unblocked nucleotides (nucleotides that are not 3′-blocked) may interfere with sequencing. For example, storage or shipping may cause 3′-blocked nucleotides to become deblocked by hydrolyzing bonds coupling the blocking group to the nucleotides, thus converting 3′-blocked nucleotides to 3′-OH nucleotides. Such hydrolysis may be reduced by lyophilizing the 3′-blocked nucleotides prior to storage or shipping, but nonetheless some 3′-OH nucleotides may become mixed with the 3′-blocked nucleotides by the time the nucleotides are to be used. Additionally, or alternatively, when the 3′-blocking groups are initially added during synthesis of the 3′-blocked nucleotides, the reaction yield may not necessarily be 100%, and as such some residual 3′-OH nucleotides may be mixed with the 3′-blocked nucleotides. If 3′-OH nucleotides are mixed with 3′-blocked nucleotides during polymerization, e.g., using an SBS polymerase and a complementary polynucleotide, the 3′-OH nucleotides may cause errors in sequencing the complementary polynucleotide. For example, the SBS polymerase may occasionally add 3′-OH nucleotides to the growing polynucleotide, but because such 3′-OH nucleotides lack a 3′-blocking group, the SBS polymerase may rapidly add another nucleotide to the growing polynucleotide rather than having to wait for addition of a reagent to remove the blocking group. As such, the 3′-OH nucleotides may speed up the polymerization (such speeding up also being called “prephasing”), in which the increased speed may inhibit the detection circuitry from being able to accurately detect and identify the detectable moieties coupled to the 3′-OH nucleotides. As such, the sequence of the complementary polynucleotide may not be fully or accurately determined.

Polishing may occur via a polishing reagent. In an implementation, the polishing reagent may include a polishing polymerase. A non-limiting example of a polishing polymerase is a thermostable polymerase, although there are many other examples of polymerases that polymerize 3′-OH nucleotides at a significantly higher rate than 3′-blocked nucleotides or substantially may not polymerize 3′-blocked nucleotides, e.g., that have not been specifically engineered for use in SBS. The polishing polymerase may polymerize 3′-OH nucleotides in the mixture, removing those nucleotides from solution, while the 3′-blocked nucleotides may remain in solution. An SBS polymerase then may be used to polymerize the 3′-blocked nucleotides, e.g., in an SBS or genotyping process, with reduced interference from 3′-OH nucleotides. A “polishing polymerase” is intended to mean an enzyme that polymerizes 3′-OH nucleotides, for example by adding 3′-OH nucleotides to a growing polynucleotide using a complementary polynucleotide, and that may polymerize 3′-blocked nucleotides at a significantly reduced rate relative to 3′-OH nucleotides, and indeed substantially may not polymerize 3′-blocked nucleotides. As such, a polishing polymerase may be considered to “selectively” polymerize 3′-OH nucleotides.

A nonlimiting example of a polishing polymerase is a “thermostable” polymerase, which refers to a polymerase that may function well at relatively high temperatures, e.g., at about 30° C. to about 100° C., or at about 40° C. to about 80° C., or at about 50° C. to about 70° C. Examples of thermostable polymerases include the Pyrococcus sp. (strain GB-D) DNA polymerase with trade name DEEP VENT® DNA Polymerase (example working temperature 75° C.), Thermus aquaticus DNA polymerase I (Taq polymerase) (example working temperature 75° C.), Bst (example working temperature 65° C.), Sulfolobus DNA Polymerase IV (example working temperature 55° C.), and Pfu (Phusion) (example working temperature 75° C.), all of which are commercially available from New England Biolabs, Inc. (Ipswich, MA). Other nonlimiting examples of polishing polymerases include Escherischia coli DNA polymerase I proteolytic (Klenow fragment) (example working temperature 37° C.) and Bsu (example working temperature 37° C.), which are commercially available from New England Biolabs, Inc.

A concentration of 3′-OH nucleotides may be reduced relative to 3′-blocked nucleotides by selectively polymerizing the 3′-OH nucleotides. For example, a polishing polymerase and a polynucleotide (template) may be mixed in an aqueous solution with a mixture of 3′-blocked nucleotides and 3′-OH nucleotides. Unlike SBS polymerases which may polymerize both 3′-blocked nucleotides and 3′-OH nucleotides relatively well, the polishing polymerase may polymerize 3′-OH nucleotides relatively well but may polymerize 3′-blocked nucleotides at a significantly lower rate than the 3′-OH nucleotides, or not do so at all in an example. A nonlimiting example of a polishing polymerase is a thermostable polymerase, although there are many other examples of polymerases that polymerize 3′-OH nucleotides at a significantly higher rate than 3′-blocked nucleotides or substantially may not polymerize 3′-blocked nucleotides, e.g., that have not been specifically engineered for use in SBS. The polishing polymerase may polymerize 3′-OH nucleotides in the mixture, removing those nucleotides from solution, while the 3′-blocked nucleotides may remain in solution. An SBS polymerase then may be used to polymerize the 3′-blocked nucleotides, e.g., in an SBS or genotyping process, with reduced interference from 3′-OH nucleotides.

In some implementations, the 3′-blocked nucleotides may be purified on the same instrument that performs the subsequent polymerization operation. For example, purifying and polymerizing the 3′-blocked nucleotides both may be performed on the same SBS instrument. As described in greater detail below, the instrument may include a device such as a “cache manifold” that may be used to heat or cool the solution for the purifying, e.g., so that the polishing polymerase may be used at a suitable temperature, and to heat or cool the solution for the polymerizing, e.g., so that the SBS polymerase may be used at a suitable temperature. The cache manifold may include a heat exchanger with inner and outer sleeves, one or both of which may be heated or cooled, and a coiled fluidic pathway that is located between the sleeves and through which the solution to be heated or cooled may flow. In some implementations, the cache manifold is a bypass cache including a heating chamber.

Used reagents may exit the flow cell through lines coupled between the flow cell and the pump 38. In the illustrated implementation, the pump includes a syringe pump having a pair of syringes 70 that are controlled and moved by an actuator 72 to aspirate the reagents and other fluids and to eject the reagents and fluids during different operations of the testing, verification and sequencing cycles. The pump assembly may include various other parts and components, including valving, instrumentation, actuators, and so forth (not shown). In the illustrated implementation, pressure sensors 74A and 74B sense pressure on inlet lines of the pump, while a pressure sensor 74C is provided to sense pressures output by the syringe pump.

Fluids used by the system may enter a used reagent selector valve 76 from the pump. This valve allows for selection of one of multiple flow paths for used reagents and other fluids. In the illustrated implementation, a first flow path leads to a first used reagent receptacle 78, while a second flow path leads through a flow meter 80 to a second used reagent receptacle 82. Depending upon the reagents used, it may be advantageous to collect the reagents, or certain of the reagents in separate vessels for disposal, and the used reagent selector valve 76 allows for such control.

It should be noted that valving within the pump assembly may allow for various fluids, including reagents, solvents, cleaners, air, and so forth to be aspirated by the pump and injected or circulated through one or more of the common lines, the bypass line, and the flow cell. Moreover, as noted above, in a presently contemplated implementation, two parallel implementations of the fluidics system shown in FIG. 2 are provided under common control. Each of the fluidics systems may be part of a single sequencing instrument, and may carry out functions including sequencing operations on different flow cells and sample libraries in parallel.

The fluidics system operates under the command of control system 46 which implements prescribed protocols for testing, verification, sequencing, and so forth. The prescribed protocols may be established in advance and include a series of events or operations for activities such as aspirating reagents, aspirating air, aspirating other fluids, ejecting such reagents, air and fluids, and so forth. Protocols may allow for coordination of such fluidic operations with other operations of the instrument, such as reactions occurring in the flow cell, imaging of the flow cell and its sites, and so forth. In the illustrated implementation, the control system 46 employs one or more valve interfaces 84 which are configured to provide command signals for the valves, as well as a pump interface 86 configured to command operation of the pump actuator. Various input/output circuits 88 may also be provided for receiving feedback and processing such feedback, such as from the pressure sensors 74A-C and flow meter 80.

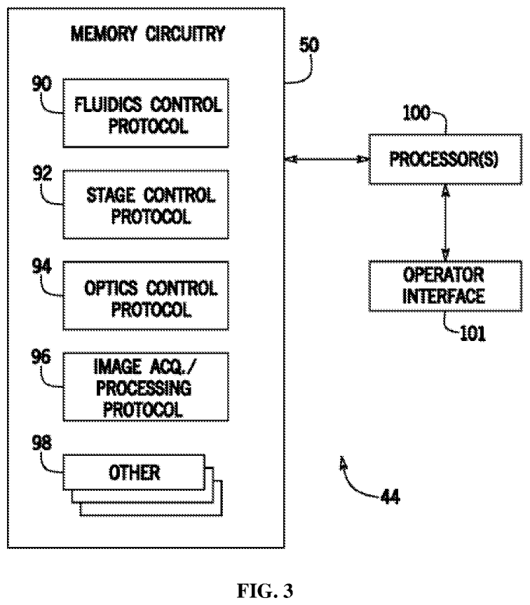

FIG. 3 illustrates certain functional components of the control/supervisory system 44. As illustrated, the memory circuitry 50 stores prescribed routines that are executed during testing, commissioning, troubleshooting, servicing, and sequencing operations. Many such protocols and routines may be implemented and stored in the memory circuitry, and these may be updated or altered from time to time. As illustrated in FIG. 3, these may include a fluidics control protocol 90 for controlling the various valves, pumps, and any other fluidics actuators, as well as for receiving and processing feedback from fluidics sensors, such as valves, and flow and pressure sensors. A stage control protocol 92 allows for moving the flow cell as desired, such as during imaging. An optics control protocol 94 allows for commands to be issued to the imaging components to illuminate portions of the flow cell and to receive returned signals for processing. An image acquisition and processing protocol 96 allows for the image data to be at least partially processed for extraction of useful data for sequencing. Other protocols and routines may be provided in the same or different memory circuitry as indicated by reference 98. In practice, the memory circuitry may be provided as one or more memory devices, such as both volatile and non-volatile memories. This memory may be within the instrument, and some may be off-board.

One or more processors 100 access the stored protocols and implement them on the instrument. As noted above, the processing circuitry may be part of application-specific computers, general-purpose computers, or any suitable hardware, firmware and software platform. The processors and the operation of the instrument may be commanded by human operators via an operator interface 101. The operator interface may allow for testing, commissioning, troubleshooting, and servicing, as well as for reporting any issues that may arise in the instrument. The operator interface may also allow for launching and monitoring sequencing operations.

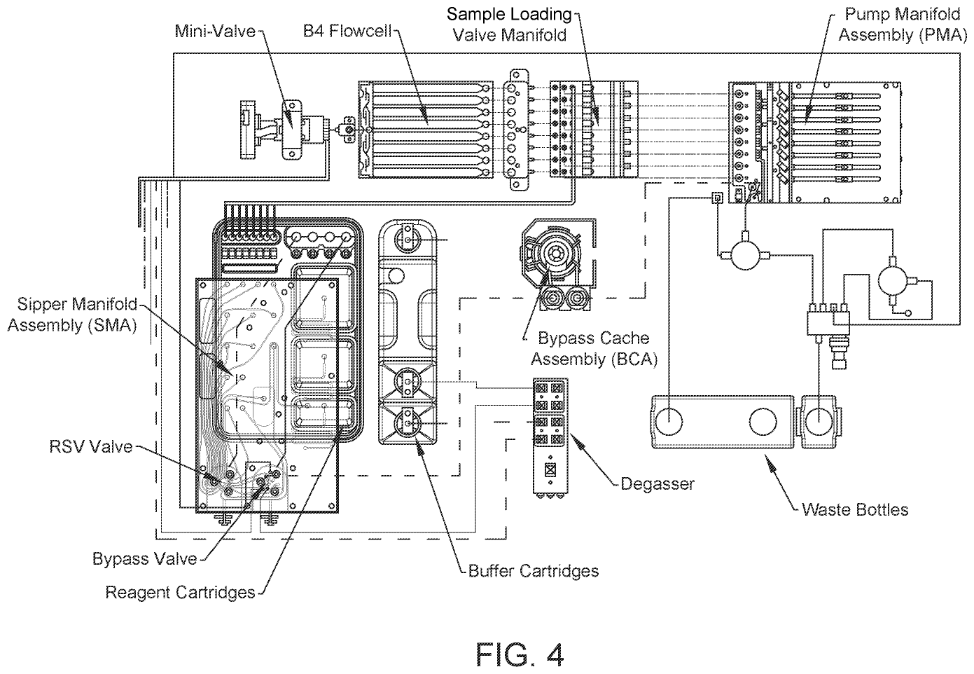

FIG. 4 illustrates a non-limiting implementation of a sequencing system with a bypass flow path compatible with hydrating and homogenizing lyophilized reagents. The bypass flow path accommodates aspirating and dispensing reagents through the bypass valve to the bypass cache for the hydration and mixing of lyophilized reagents, such that preparation of the lyophilized reagents bypasses the flow cell. The sipper manifold assembly includes the reagent selection valve, the bypass valve, and multiple sippers. The lyophilized reagent nozzle sipper may be mounted on a movable stage that, for example, may be movable in one or more directions.

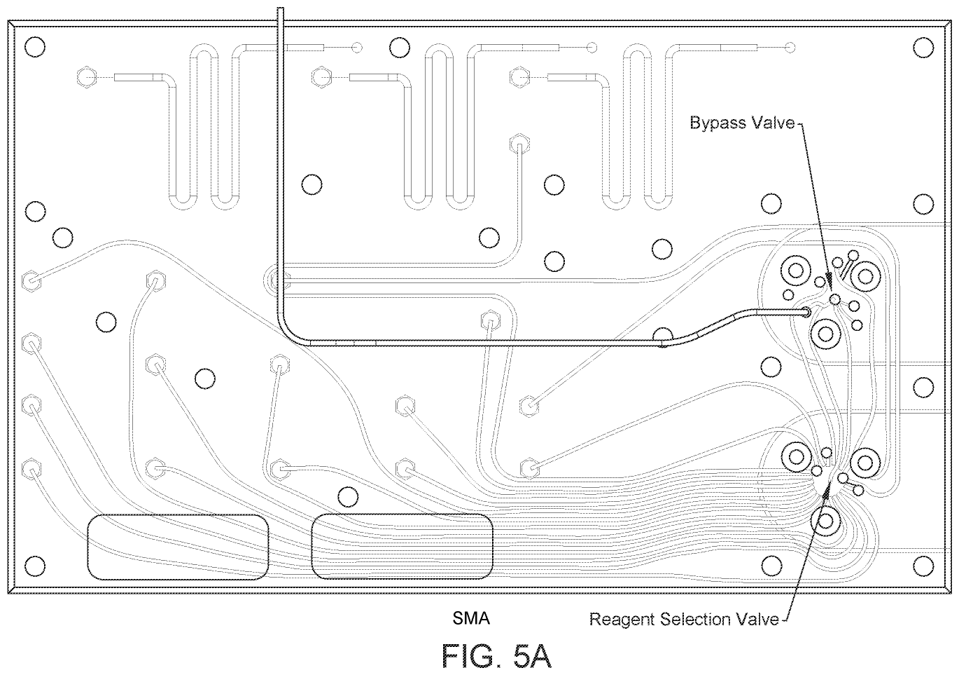

FIGS. 5A and 5B illustrate two different views of a non-limiting example of a sipper manifold assembly, including a reagent selector valve and a bypass vale.

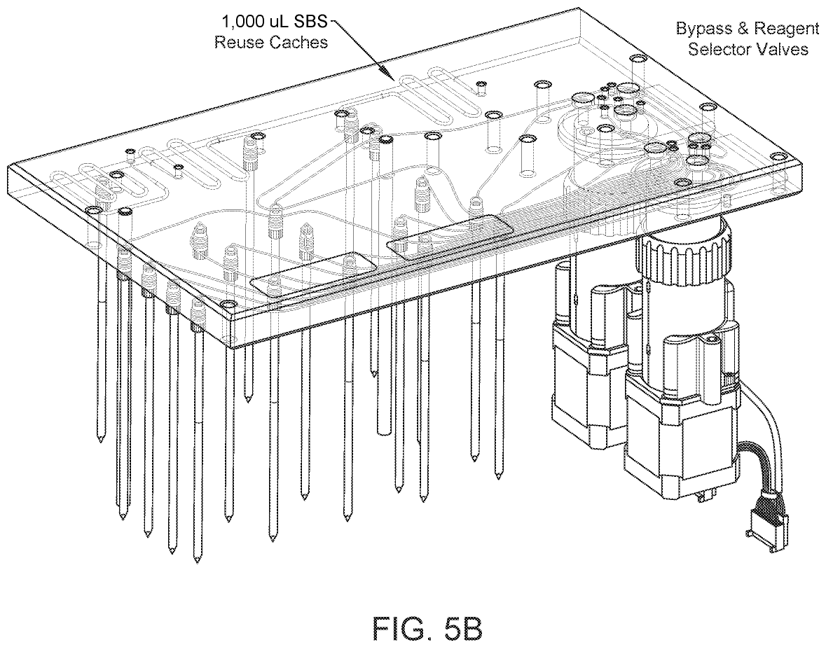

FIG. 6 illustrates a sipper manifold assembly, including the reagent selector valve, bypass valve, wells for hydration fluids, buffers, samples, and lyophilized reagents, as well as sippers and nozzle sippers for each. Lyophilized reagent nozzle sippers may move in one or more directions, including along the z-axis, e.g., vertically in the lyophilized reagent well or vessel to vary the distance the between the nozzle sipper tip and the bottom of the bottom of the well depending on which step is being implemented, e.g., hydration, dilution, mixing, etc.

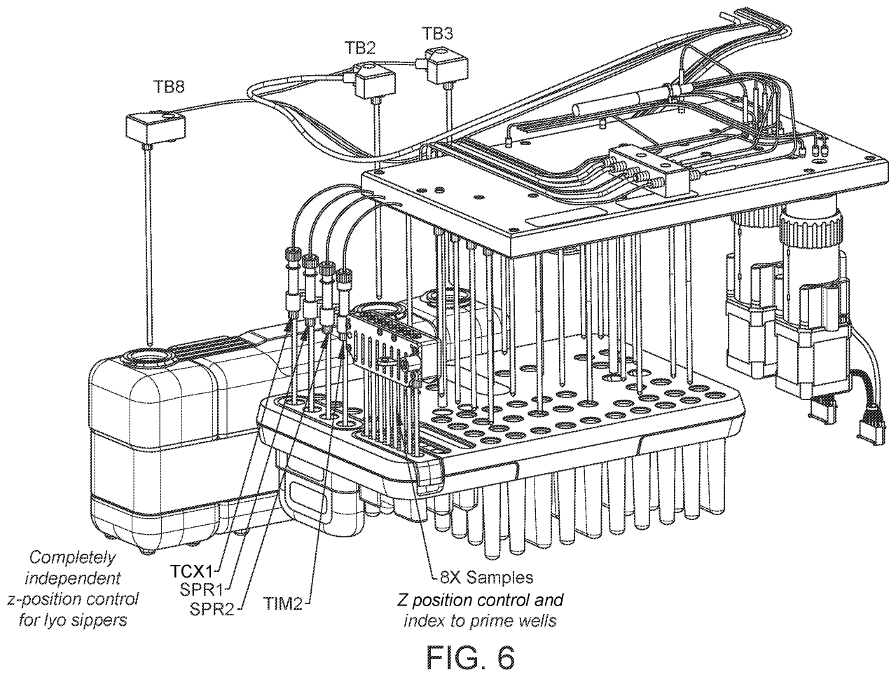

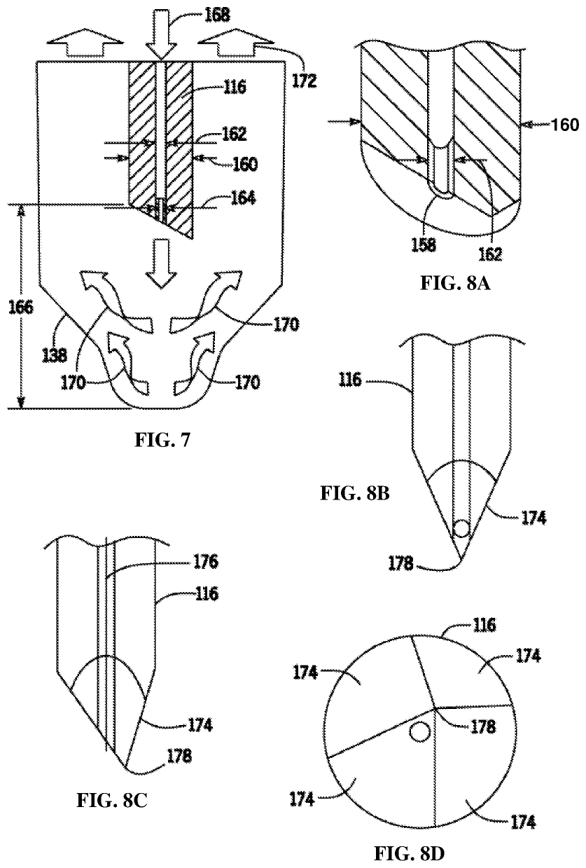

As disclosed herein, use of the mixing channel with a nozzle sipper may promote vorticity in the destination recipient and provides excellent mixing of reagents and the template despite substantial differences in fluid properties of the reagents. Moreover, these structures and techniques enable automated mixing with little or no human interaction. An example nozzle sipper for use in these techniques is illustrated an FIGS. 7 and 8A-8C. As shown in FIG. 7, the nozzle sipper has an elongated body with a central lumen (cavity) extending along its length and a tip at its distal end. A nozzle is provided at the tip to reduce the inner diameter of the sipper at this location to increase the velocity of fluids aspirated and ejected through the sipper. In the illustrated implementation, the nozzle is formed as an insert 158 that is lodged in the distal end or tip of the sipper. Other structures, such as caps, machined, formed, upset regions, and so forth could form the nozzle.

In the illustrated implementation, the sipper has a nominal outer diameter 160 of about 0.125 inches (3.175 mm), and a nominal inner diameter 162 of 0.020 inches±0.001 inches (0.508 mm). In some examples, the lyophilized reagent sipper has a nominal inner diameter 162 of from about 0.0200 inches±0.002 inches to about 0.030 inches±0.002 inches, and including all values, ranges, and subranges therein (e.g., 0.0215 inches±0.002 inches). The nozzle, on the other hand, has a nominal inner diameter 164 of 0.010 inches±0.001 inches (0.254 mm, although some implementations may feature a nozzle inner diameter ranging up to between 0.20 and 0.28 mm). Of course, other sizes and dimensions may be utilized to provide the desired mixing. Further, in the illustrated implementation, the nozzle sipper 116 is positioned at a height 166 above the bottom of the recipient 138 of about 2 mm to about 10 mm, including all values, ranges, and subranges therein. As the reagents are injected into the recipient, then, as indicated by reference 168, vorticity within the recipient is enhanced by virtue of the increased velocity of the reagents moving through the nozzle, thereby enhancing mixing in the recipient, as indicated by arrows 170 in FIG. 7. The mixed reagents are allowed to rise in the recipient as indicated by reference 172.

FIG. 8A illustrates the distal end of the nozzle sipper in somewhat greater detail. As can be seen in the figure, the nominal inner diameter 162 of the sipper is reduced by the nozzle insert 158, in this case to approximately one half of the inner diameter of the sipper (the nozzle insert, in this example, is tubular in shape). An implementation of the distal end is illustrated in FIGS. 8B, 8C and 8D. As shown here, the nozzle sipper has a faceted lower extremity including four facets 174, giving the appearance of a wedged shape to the nozzle sipper tip. The sipper has a centerline 176, and the facets meet in an apex 178 that is offset or eccentric with respect to the centerline 176. This geometry of the distal end reduces or avoids dragging or scraping of the recipient as the sipper is lowered into the recipient, or as the recipient is raised around the sipper. It may be noted, however, that in the illustrated implementation, the insert has a lower contour that matches the contour of the tip (e.g., one or more of the angled facets). Put another way, the insert may be shape-compliant with the faceted or the wedged shape of the distal end of the nozzle sipper. Moreover, it may be noted that in a presently contemplated implementation the sipper and nozzle are made of an engineering plastic, such as polyetheretherketone (PEEK). Such materials may provide chemical resistance to the reagents and any solvents used in the process.

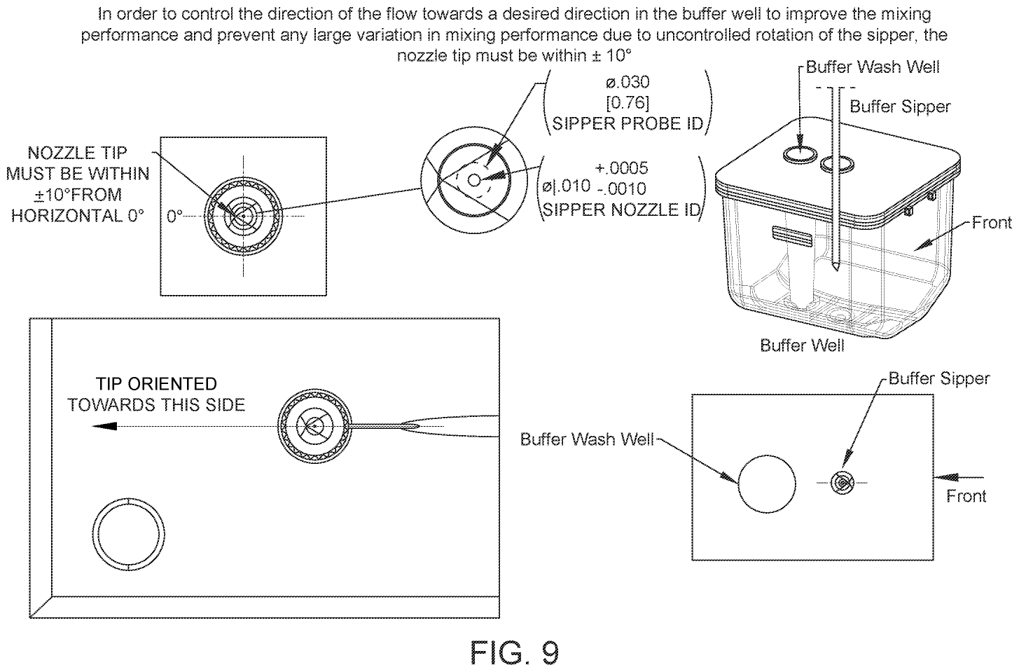

FIG. 9 illustrates a non-limiting implementation of a sipper in a well, and the sipper nozzle tip positioned within ±10° from horizontal 0°. The position of the sipper nozzle tip affects the mixing performance, where uncontrolled rotation of the sipper may result in large variation in mixing performance.

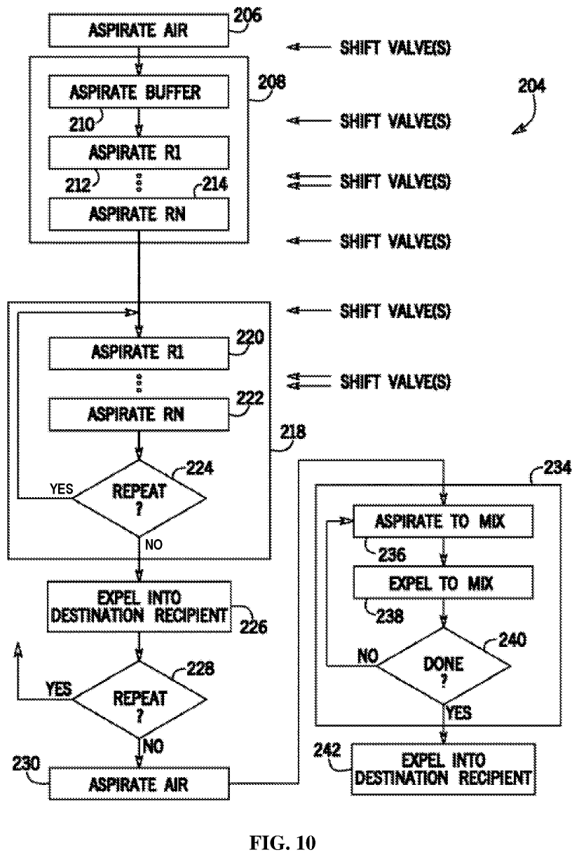

FIG. 10 is a flow chart illustrating example logic for aspirating and mixing reagents and a sample template. Following the flow chart of FIG. 10, a control logic 204 may begin with aspirating air at 206 to remove existing liquid from flow paths through which previous mixtures of reagents may have been routed. For example, any leftover liquid remaining in flow path 142, which links reagent selector valve 66 with destination recipient 136, may be aspirated with air (i.e., such that the liquid is replaced with air) so that any new mixture of reagents that is subsequently delivered to the destination recipient via the flow path 142 is not coming into contact with the leftover liquid. The transfer sequence may then begin with a priming sequence as indicated by reference 208 in FIG. 10. In general, these events allow for drawing the reagents initially into the system. In somewhat greater detail, returning to FIG. 10, a buffer may be aspirated as indicated at 210. This buffer may include a liquid selected so as to be non-reactive or relatively inert with respect to the reagents and may be used as an incompressible working fluid that extends, at least in part, between the pump and the reagents to allow for more precise metering of the reagents into the mixing volume in the following steps, if desired. The first reagent may then be aspirated in a priming event as indicated at 212 in FIG. 10, followed by aspiration of any number of other reagents, through the aspiration of the final reagent at 214. In a presently contemplated implementation, for example, three such reagents are aspirated in the priming sequence.

In the logic illustrated in FIG. 10, the reagents to be mixed are then aspirated in a transfer sequence 218. The transfer sequence continues with aspiration of the first reagent as indicated at 220, followed by aspiration, one-by-one, of each of the additional reagents until the final reagent is aspirated as indicated at 222. As before, in a presently contemplated implementation three reagents are aspirated in this sequence. As noted above, in a presently contemplated implementation a number of sets of the reagents are aspirated in relatively small quantities to create a sequence of the reagents, and thereby to promote pre-mixing. Thus, at 224 the logic may determine whether all sets of the reagents have been aspirated, and if not, return to 220 to continue aspirating additional sets. It may also be noted that in the presently contemplated implementation all sets contain all reagents selected for mixing, although this need not be the case. Moreover, different volumes or quantities of reagents could be aspirated in the various sets. Once all of the reagents have an aspirated, control may advance beyond the transfer sequence.

As shown in FIG. 10, each successive aspiration (or ejection) of reagents or pre-mixed reagents may involve controlling one or more of the valves described above, as well as the pump. That is, to aspirate the individual reagents, the reagent selector valve may be shifted to direct negative pressure to the sipper for the corresponding recipient of the selected reagent. The pump may similarly be commanded to draw reagent (or air or buffer or template), and to express aspirated fluids in accordance with a prescribed protocol. A mixing protocol may be predetermined and stored in a memory circuitry described above and carried out in an automated or semi-automated fashion based upon the sequencing operation, also defined in the memory circuitry. Protocols may be executed by the processing and control circuitry which, through appropriate interface circuitry commands operation of the valves and pump.

Once reagents have been aspirated, aspirated fluids may be ejected into a destination recipient as indicated at 226 in FIG. 10. As noted above, in an implementation, this may be done through the nozzle sipper where mixing begins by virtue of the increased velocity of the reagents through the nozzle and the resulting vorticity in the destination recipient. In certain implementations, aspiration may be further performed as indicated at reference 228 in FIG. 10. Thereafter, the aspirated reagents may be ejected into a destination recipient. This sequence may be followed by aspiration of air as indicated by reference numeral 230 in FIG. 10 (e.g., to remove as much liquid as possible from the bypass line, mixing channel, template channel, and sipper). It may also be noted that in some implementations, the nozzle sipper, or the recipient, or both may be moved with respect to the other (e.g., vertically) during aspiration and ejection to further help mix striated samples and reagents.

Following aspiration and partial pre-mixing in the mixing volume or channel by the operations described above, mixing may be performed by repeatedly moving reagents in the channel, and between the channel and the destination recipient through a nozzle sipper. For this, a series of mixing cycles may be implemented in a mixing sequence 234. In this sequence, the combined reagents and template may be aspirated at 236 and ejected back into the destination recipient at 238. The logic may repeatedly determine whether all of these desired mixing cycles have been performed at 240, and continue until all such cycles are complete. As may be seen, each may involve a relatively short negative pressure event followed by a relatively short positive pressure event. These events may effectively aspirate the combined reagents and template into the mixing volume or channel through the nozzle sipper, and return the progressively mixed reagents and template to the destination recipient through the nozzle. While any desired volume may be displaced in this process, in a presently contemplated implementation, about 2,000 μL to about 4,000 μL, including all values, ranges, and subranges therein, are aspirated from and ejected into the destination recipient in each mixing cycle, although other implementations may dispense about 500 μL or 1500 μL, depending on the size of the flow cells used. At the end of a mixing process, mixed reagents and template may be returned to a destination recipient for proceeding with the sequencing operation.

It may be noted that in an implementation, the nozzle sipper may effectively increase velocity of reagents (and mixed reagents) as they are mixed during aspiration and ejection. Increase in velocity may increase kinetic energy to aid in mixing. For example, in an implementation, a nozzle may accelerate a mixture to at least about 1600 mm/s at a flow rate of at least about 5,000 μL/min. In non-limiting implementation, the lyophilized nozzle sipper accelerates the mixture such that the flow rate is about 2800 μL/min. to about 6000 μL/min.

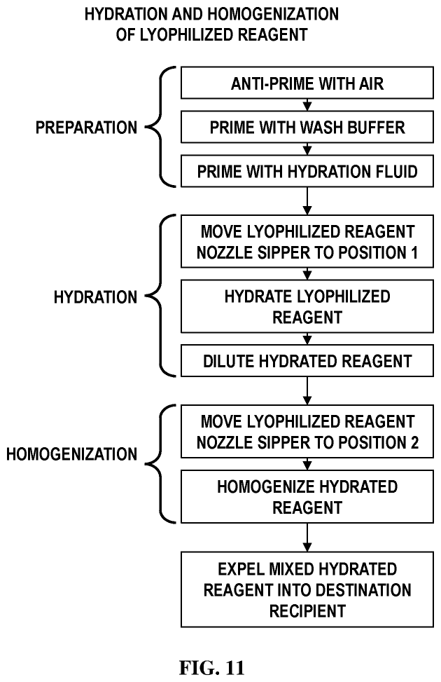

FIG. 11 is a diagrammatical overview of an example protocol for hydration and homogenization of a lyophilized reagent. In a preparation step, the sippers are anti-primed with air, the bypass cache and fluid paths are primed with wash buffer, and the hydration fluid is primed. In a hydration step, the lyophilized reagent nozzle sipper is extended into the lyophilized reagent well or vessel to a first position (position 1), and the lyophilized reagent is hydrated and then diluted with hydration fluid. In a homogenization step, the lyophilized reagent nozzle sipper is further extended into the lyophilized reagent well or vessel to a second position (position 2), and the hydrated reagent is mixed to a desired degree of homogenization.

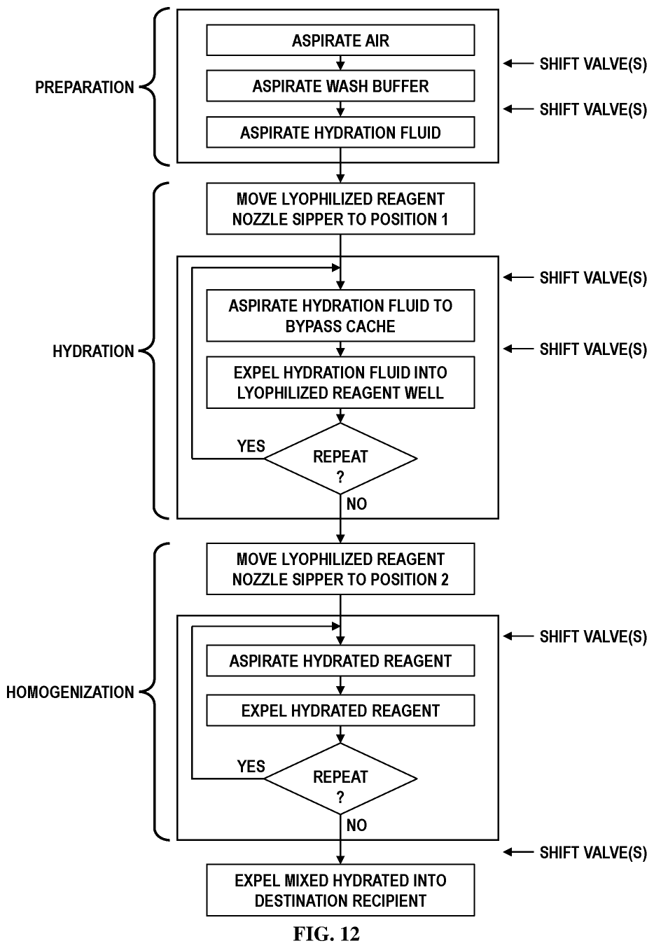

FIG. 12 is a flow chart illustrating an example logic for hydrating and homogenizing a lyophilized reagent. During preparation, air is aspirated to anti-prime sippers, wash buffer is aspirated to prime the bypass cache and fluid paths, and hydration fluid is aspirated for priming. During hydration, the lyophilized reagent nozzle sipper is controlled to move to a first position in the lyophilized reagent well or vessel, hydration fluid is aspirated to the bypass cache and expelled into the lyophilized reagent well, thereby hydrating the lyophilized reagent. Hydration fluid may be aspirated to the bypass cache and expelled into the hydrated reagent well to dilute the hydrated reagent. In some implementations, the hydration step includes over aspirating from the hydration fluid well and under dispensing into the lyophilized reagent well. In an optional dilution step, a second volume of hydration fluid is aspirated to the bypass cache and then dispensed into the lyophilized reagent well, thereby diluting the hydrated reagent. During homogenization, a lyophilized reagent nozzle sipper may be controlled to move to a second position in a lyophilized reagent well or vessel and hydrated reagent may be aspirated and expelled back into the same well. In some implementations a flow rate during aspirating and expelling varies to increase efficiency of the homogenization step.

In a mixing step, the lyophilized reagent nozzle sipper is extended into the lyophilized reagent well to a second position, the second position being closer to the bottom of the well than the first position; a mixing volume is aspirated and then dispensed back into the well; and the aspirating and dispensing of the mixing volume is repeated one or more times to homogenize the hydrated reagent. In some implementations, the lyophilized reagent is in the form of a cake.

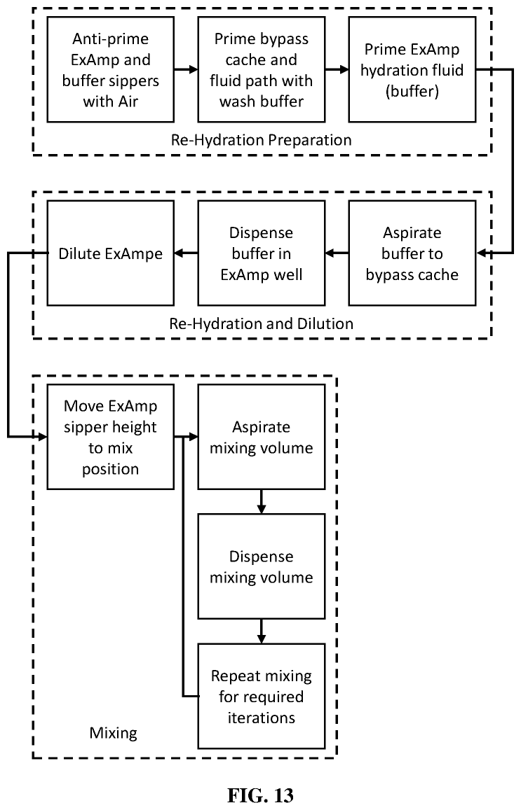

FIG. 13 is a diagrammatical overview of a non-limiting example workflow of the hydration and homogenization of a lyophilized reagent (e.g., exclusion amplification reagent or ExAmp). In a hydration preparation step, the lyophilized reagent nozzle sipper (e.g., ExAmp nozzle sipper) is extended into the lyophilized reagent well to a first position and anti-primed with air; the hydration fluid sipper is also anti-primed with air. The bypass circuit (e.g., including the bypass cache and the bypass flow path) is primed with wash buffer; and the hydration fluid is primed. In some implementations, a hydration fluid sipper may be primed and an air slug of from about 100 μl to about 200 μl, including all values, ranges, and subranges therein, may be generated between the wash buffer and the hydration fluid. In a hydration step, a first volume of the hydration fluid is aspirated to the bypass cache and then dispensed into the lyophilized reagent well, thereby forming hydrated reagent. In some implementations, the hydration step includes over aspirating from the hydration fluid well and under dispensing into the lyophilized reagent well. In an optional dilution step, a second volume of hydration fluid is aspirated to the bypass cache and then dispensed into the lyophilized reagent well, thereby diluting the hydrated reagent. In a mixing step, the lyophilized reagent nozzle sipper is extended into the lyophilized reagent well to a second position, the second position being closer to the bottom of the well than the first position; a mixing volume is aspirated and then dispensed back into the well; and the aspirating and dispensing of the mixing volume is repeated one or more times to homogenize the hydrated reagent. In some implementations, the lyophilized reagent is in the form of a cake. In some implementations, the lyophilized reagent is ExAmp. In some implementations, the lyophilized reagent is an incorporation lyophilized reagent, such as fully functionalized nucleotides, or ffNs.

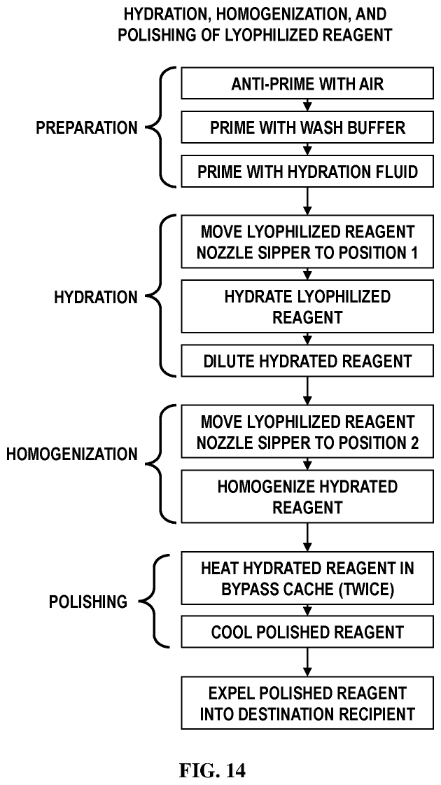

FIG. 14 is a diagrammatical overview of an example protocol for hydration, homogenization, and polishing of a lyophilized reagent. Preparation, hydration, and homogenization steps are described above in FIG. 11. In a polishing step, the homogenized hydrated reagent is aspirated to the bypass cache, heated, and dispensed back into the same well or vessel. The once-heated reagent is then aspirated to the bypass cache and heated a second time and then cooled in the bypass cache before being expelled back into the same well.

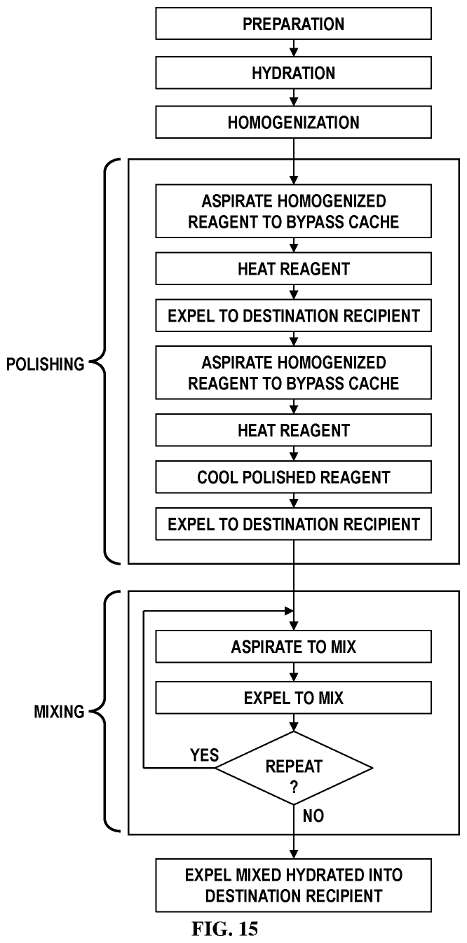

FIG. 15 is a flow chart illustrating an example logic for hydrating, homogenizing, and polishing a lyophilized reagent. In some implementations, polished reagent may be expelled into a different well containing a different substance and a mixing protocol implemented to mix the polished reagent and the different substance. In some implementations, polished reagent may further be mixed with one, two, or more additional substances. In a non-limiting example, the lyophilized reagent may include ffNs, which may be hydrated, homogenized, polished, and mixed with additional substances, such as polymerase, taq, and buffer, as described in greater detail below.

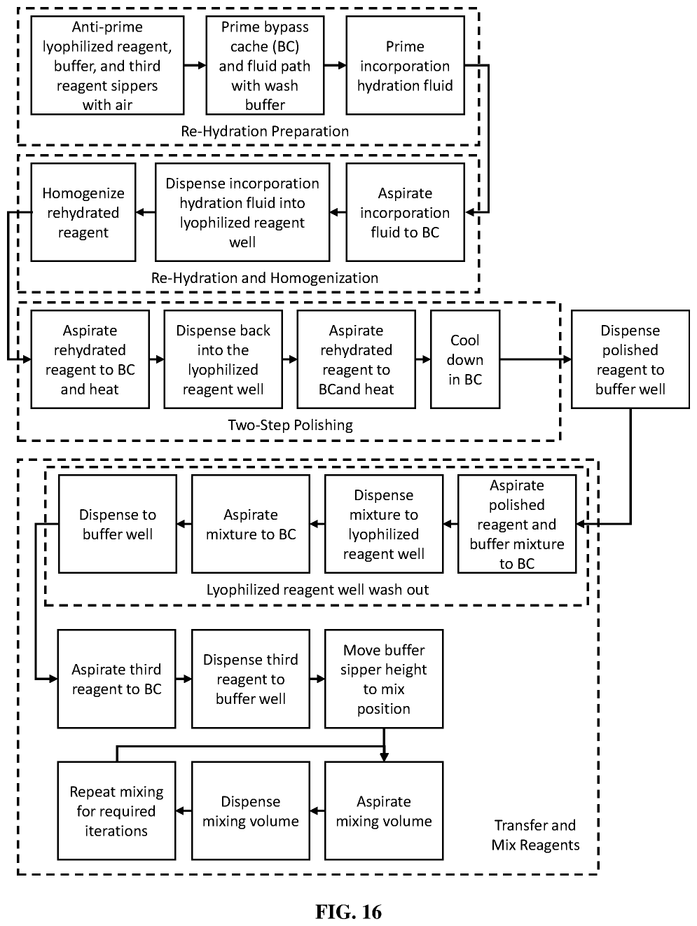

FIG. 16 is a flow chart illustrating an example workflow of the hydration and homogenization of an incorporation lyophilized reagent, followed by polishing and further mixing. In a preparation step, the lyophilized reagent nozzle sipper is extended into the lyophilized reagent well to a first position above the lyophilized reagent. In some implementations, the lyophilized reagent is in the form of a cake. In some implementations, the lyophilized reagent may include fully functional nucleotides (ffNs). The lyophilized reagent nozzle sipper, buffer sipper, and additional reagent sippers are anti-primed with air. In some implementations, additional reagents may be a polymerase. A bypass circuit (e.g., bypass cache and bypass flow path) may be primed with wash buffer; and the incorporation hydration fluid is primed. In a hydration step, a first volume of the incorporation hydration fluid is aspirated to the bypass cache and then dispensed into the lyophilized reagent well, thereby forming hydrated reagent. In some implementations, the hydration step may include over aspirating from the hydration fluid well and under dispensing into the lyophilized reagent well. In an optional dilution step, a second volume of hydration fluid is aspirated to the bypass cache and then dispensed into the lyophilized reagent well, thereby diluting the hydrated reagent. In a two-step polishing step, the hydrated reagent is aspirated to the bypass cache and heated a first time to polish; dispensed back into the hydrated reagent well; aspirated to the bypass cache and heated a second time to polish; and cooled in the bypass cache. In a transfer and mixing step, the polished reagent is dispensed to the buffer well containing a buffer fluid. In a lyophilized reagent well wash out step, the buffer fluid and the polished reagent mixture is aspirated to the bypass cache, dispensed into the lyophilized reagent well, aspirated to the bypass cache, and dispensed into the buffer well. In a further mixing step, an additional reagent is aspirated to the bypass cache and then dispensed into the buffer well. The lyophilized reagent nozzle sipper is extended into the buffer well to a second position, where the second position is between the first position and the bottom of the well. Subsequently, the mixture of polished reagent, buffer fluid, and added reagent is aspirated and dispensed one or more times to mix the reagents.

In another aspect, provided is an instrument including: a housing; a fluid manifold disposed within the housing, the fluid manifold including multiple channels fluidly connected to lyophilized reagent nozzle sippers that extend to a first position or a second position into different corresponding wells, each well associated with a lyophilized reagent, wherein the lyophilized reagent nozzle sippers contact the hydrated reagent when in the second position; a reagent selector valve disposed within the housing and operatively connected to at least two of the channels of the manifold; a bypass valve disposed within the housing and operatively connected to the reagent selector valve; a bypass cache disposed within the housing and operatively connected to the bypass valve; and a pump disposed within the housing and operatively connected to the channels of the fluid manifold, and fluidly connected to the bypass cache.

It is to be understood that any features of the instrument may be combined together in any desirable manner. Moreover, it is to be understood that any combination of features of the instrument and/or of the example systems and/or of the method may be used together, and/or that any features from either or any of these aspects may be combined with any of the examples disclosed herein.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood.

It is to be appreciated that certain aspects, modes, implementations, variations, and features of the present disclosure are described below in various levels of detail in order to provide a substantial understanding of the present technology. Unless otherwise noted, all technical and scientific terms used herein generally have the same meaning as commonly understood by one of ordinary skill in the art. The use of the term “including” as well as other forms is not limiting. The use of the term “having” as well as other forms is not limiting. As used in this disclosure, whether in a transitional phrase or in the body of the claim, the terms “include(s)” and “including” are to be interpreted as having an open-ended meaning. That is, the terms are to be interpreted synonymously with the phrases “having at least” or “including at least.”

It is also to be understood that the use of “to,” e.g., “a valve to switch between two flow paths,” may be replaceable with language such as “configured to,” e.g., “a valve configured to switch between two flow paths”, or the like.

Terms such as “about,” “approximately,” “substantially,” “nominal,” or the like, when used in reference to quantities or similar quantifiable properties, are to be understood to be inclusive of values within ±10% of the values specified, unless otherwise indicated.

In the present disclosure, reference is made to the accompanying drawings that form a part hereof, and in which is shown by way of illustration specific implementations which may be practiced. These implementations are described in detail to enable those skilled in the art to practice the disclosure, and it is to be understood that other implementations may be utilized and that structural, logical and electrical changes may be made without departing from the scope of the present disclosure.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although preferred implementation have been depicted and described in detail herein, it will be apparent to those skilled in the relevant art that various modifications, additions, substitutions, and the like can be made without departing from the spirit of the subject matter disclosed herein and these are therefore considered to be within the scope of subject matter as defined in the claims which follow.

1-41. (canceled)

42. A system comprising:
a fluid manifold comprising multiple lyophilized reagent nozzle sippers and a bypass valve, the lyophilized reagent nozzle sippers each comprising a distal tip and extending into a corresponding lyophilized reagent well containing a lyophilized reagent therein such that before hydration the distal tip does not contact the lyophilized reagent and after hydration the distal tip contacts hydrated reagent, the bypass valve fluidly connected to the lyophilized reagent nozzle sippers;
a pump fluidly connected to the bypass valve; and
a control circuitry operatively connected to the lyophilized reagent nozzle sippers, bypass valve, and pump, the control circuitry controlling the lyophilized reagent nozzle sippers, the bypass valve, and the pump to automatically hydrate the lyophilized reagents and homogenize the hydrated reagent.

43. The system of claim 42, further comprising a bypass line between the bypass valve and the pump, wherein the bypass line is fluidly connected to the pump.

44. The system of claim 42, further comprising a bypass cache between the pump and the bypass valve, the bypass cache comprising a heating chamber, and wherein the bypass cache is fluidly connected to the bypass valve.

45. The system of claim 42, wherein the fluid manifold further comprises one or more hydration sipper and each of the one or more hydration sipper comprises a distal tip and extends into a corresponding hydration reagent reservoir containing a hydration fluid.

46. The system of claim 42, wherein one or more of
(i) the control circuitry controls the pump to hydrate the lyophilized reagent by aspirating a volume of the hydration fluid and dispensing the volume of the hydration fluid onto the lyophilized reagent in the lyophilized reagent well, resulting in a hydrated reagent;
(ii) the control circuitry controls the pump to dilute the hydrated reagent by aspirating a second volume of the hydration fluid and dispensing the second volume of hydration fluid into the lyophilized reagent well;
(iii) the control circuitry controls the pump and the lyophilized reagent nozzle sipper to homogenize the hydrated reagent by positioning the lyophilized reagent nozzle sipper such that the distal tip contacts the hydrated reagent, aspirating the hydrated reagent and dispensing it back into the lyophilized reagent well, and repeating the steps of aspirating and dispensing until the hydrated reagent is substantially homogeneous;
(iv) the control circuitry controls the pump and the bypass cache to polish the homogeneous hydrated reagent, wherein the homogeneous hydrated reagent is aspirated to the bypass cache, heated, dispensed back into the lyophilized reagent well, aspirated to the bypass cache a second time, heated a second time, cooled, and dispensed into a buffer well containing a buffer fluid;
and
any combination of (i)-(iv).

47. The system of claim 42, wherein:
(i) a flow rate when aspirating the second volume of hydrated reagent is equal to a flow rate when dispensing the second volume of hydrated reagent; or
(ii) the flow rate when aspirating the second volume of hydrated reagent is less than the flow rate when dispensing the second volume of hydrated reagent.

48. The system of claim 46, wherein the control circuitry controls the pump to add a third component to the buffer well by aspirating an amount of the third component and dispensing the amount of the third component into the buffer well.

49. A method utilizing the system of claim 42, the method comprising:
(a) performing a hydration operation comprising:
actuating the pump to aspirate the hydration fluid,
commanding one of the multiple lyophilized reagent nozzle sippers to extend to a first position into the corresponding lyophilized reagent well, and
actuating the pump to dispense the hydration fluid into the corresponding lyophilized reagent well, thereby forming the hydrated reagent; and
(b) performing a mixing operation comprising:
commanding the one of the multiple lyophilized reagent nozzle sippers to extend to a second position within the corresponding lyophilized reagent well, and
actuating the pump to mix the hydrated reagent.

50. The method of claim 49, further comprising:
(c) performing a dilution operation before the mixing operation, comprising:
actuating the pump to aspirate a dilution fluid, and
actuating the pump to dispense the dilution fluid into the corresponding lyophilized reagent well.

51. The method of claim 49, further comprising:
(d) performing a polishing operation after the mixing operation, comprising:
actuating the pump to aspirate the hydrated reagent to a bypass cache comprising a heating chamber,
commanding the heating chamber to heat the hydrated reagent,
dispensing the hydrated reagent back into the corresponding lyophilized reagent well,
actuating the pump to aspirate the hydrated reagent to the heating chamber of the bypass cache,
commanding the heating chamber to heat the hydrated reagent a second time, and
cooling the hydrated reagent, thereby forming a polished reagent.

52. The method of claim 49, further comprising:
(e) performing a second mixing operation, comprising:
actuating the pump to dispense the polished reagent into a buffer well containing a buffer fluid,
actuating the pump to aspirate a third component,
actuating the pump to dispense the third component into the buffer well, and
actuating the pump to aspirate the solution in the buffer well and dispense it back into the buffer well, thereby mixing the solution.

53. A method comprising:
implementing a hydration protocol under control of a control circuitry, comprising extending a lyophilized reagent nozzle sipper into a lyophilized reagent well to a first position above a lyophilized reagent, aspirating a volume of hydration fluid from a hydration reservoir, dispensing the volume of hydration fluid into the lyophilized reagent well to form a hydrated reagent; and
implementing a homogenization protocol under control of the control circuitry, comprising extending the lyophilized reagent nozzle sipper to a second position wherein the lyophilized reagent nozzle sipper contacts the hydrated reagent, aspirating an amount of the hydrated reagent, and dispensing the amount of hydrated reagent into the same well.

54. The method of claim 53, further comprising:
after the hydration protocol is implemented and before the homogenization protocol is implemented, implementing a dilution protocol under control of the control circuitry, wherein the dilution control comprises aspirating a dilution fluid from a dilution reservoir into a bypass cache and dispensing the dilution fluid into the lyophilized reagent well.

55. The method of claim 53, further comprising:
after the homogenization protocol is implemented, implementing a polishing protocol under control of the control circuitry, wherein the polishing protocol comprises aspirating the homogenized reagent into a bypass cache and heating the homogenized reagent in the bypass cache a first time, dispensing the homogenized reagent back into the lyophilized reagent well, aspirating the homogenized reagent into the bypass cache and heating the homogenized reagent in the bypass cache a second time, cooling the homogenized reagent, and dispensing the resulting polished reagent into a buffer well.

56. The method of claim 55, further comprising:
after the polishing protocol is implemented, implementing a mixing protocol under control of the control circuitry, wherein the mixing protocol comprises aspirating a third component and dispensing the third component into the buffer well, aspirating the mixture of polished reagent and third component and dispensing back into the buffer well.

57. The method of claim 53, wherein:
(i) during the homogenization protocol a flow rate when dispensing is equal to a flow rate when aspirating; or
(ii) during the homogenization protocol a flow rate when dispensing is greater than the flow rate when aspirating.

58. The method of claim 53, wherein:
(i) during the mixing protocol a flow rate when dispensing is equal to a flow rate when aspirating;
or
(ii) during the mixing protocol the flow rate when dispensing is greater than the flow rate when aspirating.

59. An apparatus comprising:
a lyophilized reagent sipper that is extendable from a first position to a second position and a third position, where the distance between the first position and the third position is greater than the distance between the first position and the second position.

60. The apparatus of claim 59, further comprising:
a removable cartridge comprising a well,
wherein the lyophilized reagent sipper extends into the well of the cartridge when the lyophilized reagent sipper is in the second position and the third position, and wherein the lyophilized reagent sipper does not extend into the well of the cartridge when the lyophilized reagent supper is in the first position, and
wherein the lyophilized reagent sipper extends into the well above a lyophilized cake housed within the well when the lyophilized reagent sipper is in the second position, and wherein the lyophilized reagent sipper extends into the well and into rehydrated lyophilized reagent housed within the well when the lyophilized reagent sipper is in the third position.

61. The apparatus of claim 59, wherein
the lyophilized reagent sipper further comprises a center line and a distal end, where the distal end comprises facets and a nozzle, where the facets meet at an apex that is offset or eccentric with respect to the centerline, and where the centerline extends through the nozzle.
